(19) United States
(12) Patent Application Publication
(10) Pub. No.: US 2006/0081111 A1
(43) Pub. Date: Apr. 20, 2006

(54) Two piece playing position guitar hanger

(76) Inventor: Douglas Miles Bridges, Estes Park, CO (US)

Correspondence Address: DOUGLAS M. BRIDGES, P. O. BOX 2235, ESTES PARK, CO, 80517, US

(21) Appl. No.: 11/211,345

(22) Filed: Aug. 24, 2005

Related U.S. Application Data
(60) Provisional application No. 60/620,562, filed on Oct. 20, 2004.

(51) Int. Cl. G10G 5/00

(52) U.S. Cl. 84/327

(57) ABSTRACT

Two piece guitar hanger apparatus for displaying a guitar on a wall in playing position with support braces that allow the insertion of each strap button which supports the weight of the guitar, a support dowel to prohibit the guitar from tilting, and a spacer for angled peg head guitar models to maintain sufficient space as to keep the peg head from touching the wall.

### CROSS REFERENCE TO RELATED APPLICATIONS

I am claiming priority to a Provisional Patent Application entitled Two Piece Playing Position Guitar Hanger of Ser. No. 60/620,562, filed on Oct. 20, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of musical instrument accessories and more specifically to an apparatus for hanging a guitar in playing position on a wall.

Guitar hangers have typically been designed on the premise that a guitar is hung by its neck in a vertical position. Most hangers incorporate a U shaped hanging device in which the guitar neck, nearest the peg head is inserted in order to hang the guitar.

They are typically mounted to a wall using mounting screws or to a slat board using specifically designed mounting hardware.

These hangers are typically used in music stores to display guitars and by guitar players and collectors. They allow guitars to be displayed and to be removed for inspection or for playing.

Most guitar hangers are similar in their design. The guitar neck, closest to the peg head is inserted into a U shaped holder and the guitar is held in a vertical position supported by its neck.

Most guitar hangers allow for the removal of the guitar for inspection or for playing.

Some guitar hangers allow for the guitar to be displayed in the playing position. Some of these hangers support the guitar by placing a device under the guitar neck. Some of these hangers mount to the back of the guitar body and some are incorporated into a clear display case.

The prior designs that display a guitar in a vertical position place stress on the guitar neck. A risk of scratching or damaging the finish on the neck exists when any foreign device or object remains in contact with the finish.

The designs that display a guitar in the playing position that use a device to support the neck also have the same disadvantages. The designs that attach to the back of the guitar body can damage the guitar body and do not allow for the easy removal of the guitar for inspection or for playing.

Most of these designs are visible even when the guitar is mounted on the guitar hanger, detracting from the overall visual display of the guitar.

### BRIEF SUMMARY OF THE INVENTION

The primary object of the invention is displays guitar in playing position on a wall.

Another object of the invention is places no stress on guitar neck.

Another object of the invention is no modifications to guitar.

A further object of the invention is will not harm guitar finish.

Yet another object of the invention is unique design.

Still yet another object of the invention is guitar easily lifted off to play.

Another object of the invention is hanger is virtualy invisible while guitar is mounted on the guitar hanger.

Another object of the invention is made in USA.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a two piece playing position guitar hanger apparatus comprising: two support braces that allow the insertion of each strap button which support the weight of the guitar, a support dowel to prohibit the guitar from tilting, and a spacer for angled peg head guitar models to maintain sufficient space as to keep the peg head from touching the wall.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention with guitar body superimposed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtualy any appropriately detailed system, structure or manner.

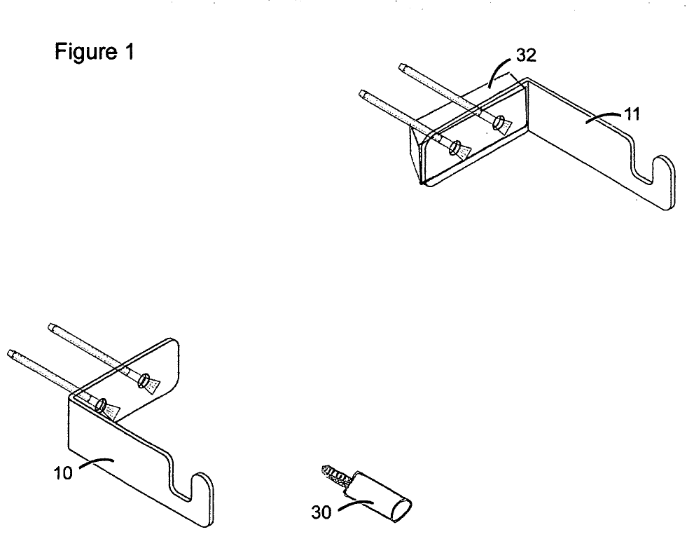

In accordance with the present invention, FIG. 1 shows a perspective view of the two piece playing position guitar hanger apparatus comprising: support braces 10 and 11 with a special U shaped cut out that allow for the insertion of each guitar strap button, located on each end of the guitar body, which supports the weight of the guitar, a support dowel 30 to prohibit the guitar from tilting, and a spacer 32 for angled peg head guitar models.

Following the preferred procedure the two piece playing position guitar hanger apparatus, support braces 10 and 11 are mounted to a wall using mounting screws preferably in a wooden stud or in a hollow wall using appropriate wall anchor mounting hardware. The spacer 32 is installed behind support brace 11 for angled peg head guitar models maintaining sufficient space as to keep the peg head from touching the wall. The support dowel 30 is mounted to the wall using mounting screws to prohibit the guitar from tilting.

The two piece playing position guitar hanger apparatus support braces 10 and 11 are positioned so as to allow the guitar to be positioned on the wall in the playing position.

The guitar is mounted onto the two piece playing position guitar hanger apparatus by way of inserting one of the guitar's strap buttons into each U shaped slot in support braces 10 and 11. The lower portion of the guitar body rests against the support dowel 30.

The guitar is now displayed in the playing position with no stress on the guitar's neck and no harm to the guitar's finish. The support dowel prevents the guitar from tilting. The spacer, when installed, maintains sufficient space as to keep the peg head from touching the wall for tilted peg head model guitars. The two piece playing position guitar hanger apparatus is virtualy invisible while the guitar is mounted on the apparatus.

The guitar can be easily removed from the two piece playing position guitar hanger apparatus by simply lifting it from the support braces 10 and 11.

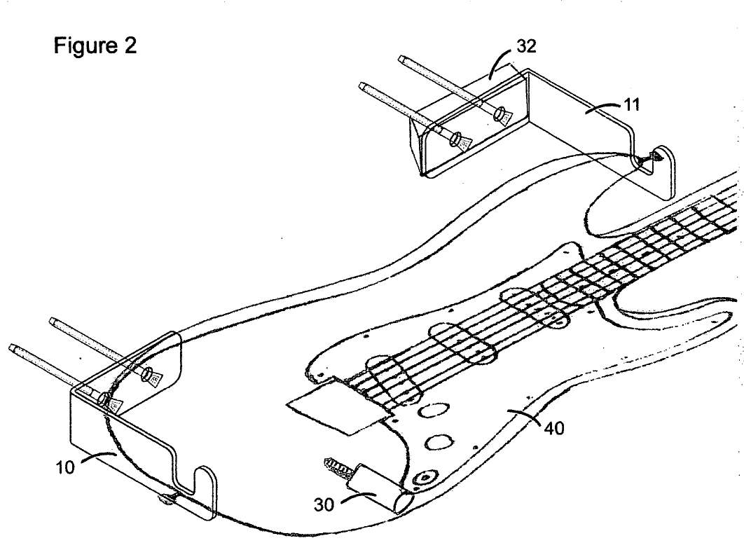

In accordance with the present invention, FIG. 2 shows an additional perspective view of the two piece playing position guitar hanger apparatus comprising: support braces 10 and 11 with a special U shaped cut out that allow for the insertion of each guitar strap button, located on each end of the guitar body, which supports the weight of the guitar, a support dowel 30 to prohibit the guitar from tilting, a spacer 32 for angled peg head guitar models, and a guitar body 40 for illustration purposes only.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Two piece guitar hanger apparatus for hanging a guitar in playing position comprising:
two support braces that allow the insertion of each strap button which supports the weight of the guitar;
a support dowel to prohibit the guitar from tilting;
and a spacer for angled peg head guitar models.
